(19) United States
(12) Patent Application Publication
(10) Pub. No.: US 2011/0292036 A1
(43) Pub. Date: Dec. 1, 2011

(54) DEPTH SENSOR WITH APPLICATION INTERFACE

(75) Inventors: Erez Sali, Savyon (IL); Tomer Yanir, Rinatya (IL); Eran Guendelman, Tel Aviv (IL); Amiad Gurman, Elkana (IL)

(73) Assignee: PRIMESENSE LTD., Tel Aviv (IL)

(21) Appl. No.: 13/098,497

(22) Filed: May 2, 2011

Related U.S. Application Data
(60) Provisional application No. 61/349,894, filed on May 31, 2010.

(51) Int. Cl. G06T 15/00

(52) U.S. Cl. 345/419

(57) ABSTRACT

A method for processing data includes receiving a depth map of a scene containing a body of a humanoid subject. The depth map includes a matrix of pixels, each pixel corresponding to a respective location in the scene and having a respective pixel depth value indicative of a distance from a reference plane to the respective location. The depth map is processed in a digital processor to extract a skeleton of at least a part of the body, the skeleton including multiple joints having respective coordinates. An application program interface (API) indicates at least the coordinates of the joints.

### CROSS-REFERENCE TO RELATED APPLICATION

This application claims the benefit of U.S. Provisional Patent Application 61/349,894, filed May 31, 2010, which is incorporated herein by reference.

### FIELD OF THE INVENTION

The present invention relates generally to methods and systems for three-dimensional (3D) mapping, and specifically to processing of 3D map data.

### BACKGROUND OF THE INVENTION

A number of different methods and systems are known in the art for creating depth maps. In the present patent application and in the claims, the term “depth map” refers to a representation of a scene as a two-dimensional matrix of pixels, in which each pixel corresponds to a respect lye location. In the scene and has a respective pixel value indicative of the distance from a certain reference location to the respective scene location. (In other words, the depth map has the form of an image in which the pixel values indicate topographic information, rather than brightness and/or color of the objects in the scene.) Depth maps may be created, for example, by detection and processing of an image of an object onto which a laser speckle pattern is projected, as described in POT International Publication WO 2007/043036 A1, whose disclosure is incorporated herein by reference.

Depth maps may be processed in order to segment and identify objects in the scene. Identification of humanoid forms (meaning 3D shapes whose structure resembles that of a human being) in a depth map, and changes in these forms from scene to scene, may be used as a means for controlling computer applications. For example, PCT International Publication WO 2007/132451, whose disclosure is incorporated herein by reference, describes a computer-implemented method in which a depth map is segmented so as to find a contour of a humanoid body. The contour is processed in order to identify a torso and one or more limbs of the body. An input is generated to control an application program running on a computer by analyzing a disposition of at least one of the identified limbs in the depth map.

Computer interfaces based on three-dimensional sensing of parts of the user's body have also been proposed. For example, PCT International Publication WO 2003/071410, whose disclosure is incorporated herein by reference, describes a gesture recognition system using depth-perceptive sensors. A three-dimensional sensor provides position information, which is used to identify gestures created by a body part of interest. The gestures are recognized based on the shape of the body part and its position and orientation over an interval. The gesture is classified for determining an input into a related electronic device.

### SUMMARY OF THE INVENTION

Embodiments of the present invention provide an enhanced interface between sensors and software that are used in creating a depth map and application programs that make use of the depth map information.

There is therefore provided, in accordance with an embodiment of the present invention, a method for processing data, including receiving a depth map of a scene containing a body of a humanoid subject, the depth map including a matrix of pixels, each pixel corresponding to a respective location in the scene and having a respective pixel depth value indicative of a distance from a reference plane to the respective location. The depth map is processed in a digital processor to extract a skeleton of at least a part of the body, the skeleton including multiple joints having respective coordinates. An application program interface (API) is provided, indicating at least the coordinates of the joints.

In a disclosed embodiment, the skeleton includes two shoulder joints having different, respective depth values. The different depth values of shoulder joints define a coronal plane of the body that is rotated by at least 10° relative to the reference plane.

In one embodiment, the API includes a first interface providing the coordinates of the joints and a second interface providing respective depth values of the pixels in the depth map.

Additionally or alternatively, receiving the depth map includes receiving a sequence of depth maps as the body moves, and processing the depth map includes tracking movement of one or more of the joints over the sequence, wherein the API includes a first interface providing the coordinates of the joints and a second interface providing an indication of gestures formed by the movement of the one or more of the joints.

In some embodiments, the scene contains a background, and processing the depth map includes identifying one or more parameters of at least one element of the background, wherein the API includes a first interface providing the coordinates of the joints and a second interface providing the one or more parameters of the at least one element of the background. In one embodiment, the at least one element of the background includes a planar element, and the one or more parameters indicate a location and orientation of a plane corresponding to the planar element.

Additionally or alternatively, when the scene contains respective bodies of two or more humanoid subjects, processing the depth map may include distinguishing the bodies from one another and assigning a respective label to identify each of the bodies, wherein the API identifies the coordinates of the joints of each of the bodies with the respective label. In one embodiment, distinguishing the bodies includes identifying an occlusion of a part of one of the bodies in the depth map by another of the bodies, wherein the API identifies the occlusion.

Further additionally or alternatively, processing the depth map includes computing a confidence value associated with an identification of an element in the scene, wherein the API indicates the identification and the associated confidence value.

There is also provided, in accordance with an embodiment of the present invention, apparatus for processing data, including an imaging assembly, which is configured to generate a depth map of a scene containing a body of a humanoid subject. A processor is configured to process the depth map to extract a skeleton of at least a part of the body, the skeleton including multiple joints having respective coordinates, and to provide an application program interface (API) indicating at least the coordinates of the joints.

There is additionally provided, in accordance with an embodiment of the present invention, a computer software product, including a computer-readable medium in which program instructions are stored, which instructions, when read by a processor, cause the processor to receive a depth map of a scene containing a body of a humanoid subject, to process the depth map to extract a skeleton of at least a part of the body, the skeleton including multiple joints having respective coordinates, and to provide an application program interface (API) indicating at least the coordinates of the joints.

There is further provided, in accordance with an embodiment of the present invention, a method for processing data, including receiving a depth map of a scene including a matrix of pixels, each pixel corresponding to a respective location in the scene and having a respective pixel depth value indicative of a distance from a reference plane to the respective location. The depth map is segmented in a digital processor to identify one or more objects in the scene. A label map is generated, including respective labels identifying the pixels belonging to the one or more objects. An indication of the label map is provided via an application program interface (API).

In a disclosed embodiment, receiving the depth map includes receiving a sequence of depth maps as the objects move, and generating the label map includes updating the label map over the sequence responsively to movement of the objects.

Additionally or alternatively, when at least one of the objects includes multiple segments, generating the label map includes assigning a single label to all of the segments.

Further additionally or alternatively, segmenting the depth map includes recognizing an occlusion of a part of one of the identified objects in the depth map by another object, and generating the label map includes identifying the occlusion in the label map.

There is moreover provided, in accordance with an embodiment of the present invention, apparatus for processing data, including an imaging assembly, which is configured to generate a depth map of a scene including a matrix of pixels. A processor is configured to segment the depth map to identify one or more objects in the scene, to generate a label map including respective labels identifying the pixels belonging to the one or more objects, and to provide an indication of the label map via an application program interface (API).

There is furthermore provided, in accordance with an embodiment of the present invention, a computer software product, including a computer-readable medium in which program instructions are stored, which instructions, when read by a processor, cause the processor to receive a depth map of a scene including a matrix of pixels, to segment the depth map to identify one or more objects in the scene, to generate a label map including respective labels identifying the pixels belonging to the one or more objects, and to provide an indication of the label map via an application program interface (API).

The present invention will be more fully understood from the following detailed description of the embodiments thereof, taken together with the drawings in which:

### BRIEF DESCRIPTION OF THE DRAWINGS

FIG. 1 is a schematic, pictorial illustration of a 3D user interface system, in accordance with an embodiment of the present invention;

FIG. 2 is a block diagram that schematically illustrates elements of a 3D imaging assembly and a computer, in accordance with an embodiment of the present invention;

FIG. 3 is a block diagram that schematically illustrates software components of a computer system that uses 3D mapping, in accordance with an embodiment of the present invention;

FIG. 4 is a schematic graphical representation of a skeleton that is extracted from a 3D map, in accordance with an embodiment of the present invention; and

FIG. 5 is a schematic graphical representation showing elements of a scene that have been extracted from a 3D map, in accordance with an embodiment of the present invention.

### DETAILED DESCRIPTION OF EMBODIMENTS OVERVIEW

Depth maps provide a wealth of information, particularly when they are presented in a continuous stream over time. Handling this large volume of information is a challenge for software application developers, whose interest and skills are not generally directed to processing of the depth information, but rather to using high-level information regarding people in the scene and their movements in controlling interactive applications. For example, various computer games have been developed that use motion input from an implement held by a user or a marker attached to the user in order to interact with objects on the display screen. Games and other applications based on depth maps, however, have developed only slowly due to the difficulties inherent in capturing, processing, and extracting high-level information from such maps.

Embodiments of the present invention that are described hereinbelow address this problem by providing middleware—supporting software for extracting information from a depth map—with an application program interface (API) for application software developers. The middleware processes depth maps of a scene that are output by an imaging assembly in order to extract higher-level information about the scene, and particularly about humanoid forms in the scene. Methods for processing depth maps that may be used in this context are described, for example, in U.S. patent application Ser. Nos. 12/854,187 and 12/854,188, both filed Aug. 11, 2010, whose disclosures are incorporated herein by reference. The API enables applications to access this information in a structured and straightforward way.

In some embodiments, the middleware reconstructs a skeleton of at least a part of the body of a humanoid subject in the scene. The API indicates coordinates of the joints of the skeleton, which may include both location and orientation coordinates. These coordinates—particularly the coordinates of the two shoulders may indicate that the body is turned at least partly away from the imaging assembly, i.e., that the coronal plane of the body (defined as a vertical plane that divides the body into anterior and posterior sections) is rotated relative to the reference plane of the imaging assembly. The middleware and API can be configured to measure and give an indication of this rotation angle, as well as rotations of the skeleton about horizontal axes. The measured angles may be anywhere in the range between 0° and 360°, typically with angular resolution of 10° or better, including rotations of 90°, at which the body is turned sideways relative to the reference plane, with the coronal plane parallel to the optical axis of the imaging assembly.

Other information provided by the API regarding the skeleton may include, for example, confidence values associated with joint coordinates, as well as identifiers associated with the parts of different skeletons, particularly when there are multiple bodies in the scene. The identifiers are useful to application developers in separating the actions of two simultaneous users, such as game participants, even when one of the bodies partly occludes the other in the depth map. The confidence values can be useful in making application-level decisions under conditions of conflicting input information due to noise or other uncertainty factors.

The API may provide different levels of information—not only the coordinates of the joints, but also other objects at lower and higher levels of abstraction. For example, at a lower level, the API may provide the actual depth values of the pixels in the depth map. Alternatively or additionally, at a higher level, the middleware may track movement of one or more of the joints over a sequence of frames, and the API may then provide an indication of gestures formed by the movement. As a further option, the middleware may identify elements of the background in the scene, and the API may provide parameters of these elements, such as the locations and orientations of planes corresponding to the floor and/or walls of a room in which the scene is located.

### System Description

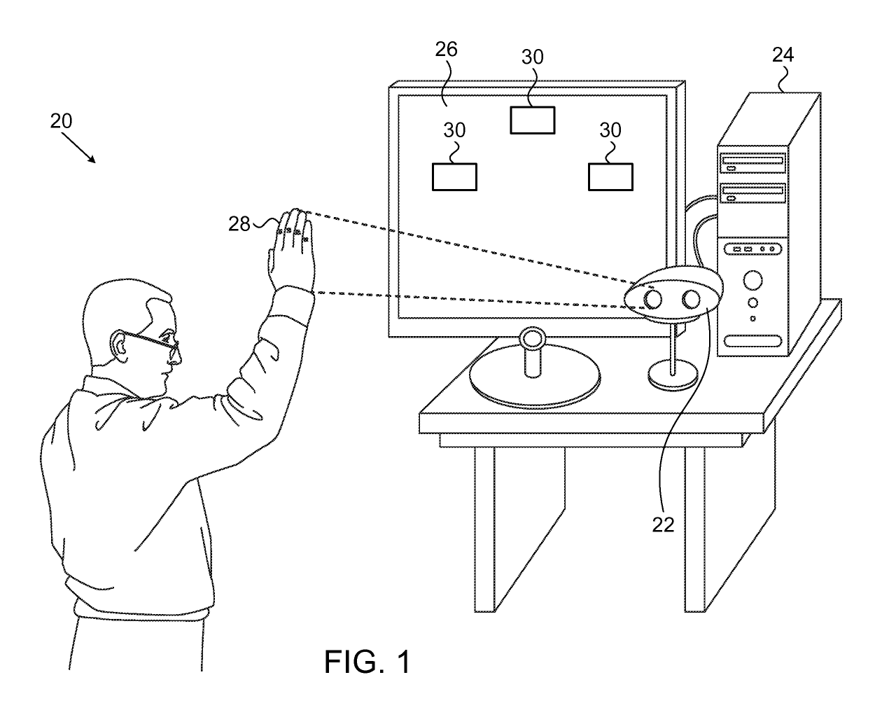

FIG. 1 is a schematic, pictorial illustration of a 3D user interface system 20 for operation by a user 28 of a computer 24, in accordance with an embodiment of the present invention. The user interface is based on a 3D imaging assembly 22, which captures 3D scene information that includes at least a part of the body of the user. Assembly 22 may also capture color video images of the scene. Assembly 22 generates a sequence of frames containing 3D map data (and possibly color image data, as well). Middleware running either on a processor in assembly 22 or on computer 24 (or distributed between the assembly and the computer) extracts high-level information from the map data. This high-level information is provided via an API to an application running on computer 24, which drives a display screen 26 accordingly.

The middleware processes data generated by assembly 22 in order to reconstruct a 3D map, including at least a part of the user's body. The term “3D map” refers to a set of 3D coordinates representing the surface of a given object or objects, such as the user's body. In one embodiment, assembly 22 projects a pattern of spots onto the scene and captures an image of the projected pattern. Assembly 22 or computer 24 then computes the 3D coordinates of points in the scene (including points on the surface of the user's body) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from assembly 22. Methods and devices for this sort of triangulation-based 3D mapping using a projected pattern are described, for example, in PCT International Publications WO 2007/043036, WO 2007/105205 and WO 2008/120217, whose disclosures are incorporated herein by reference. Alternatively, system 20 may use other methods of 3D mapping, based on single or multiple cameras or other types of sensors, as are known in the art.

In the present embodiment, system 20 captures and processes a sequence of three-dimensional (3D) maps containing user 28, while the user moves his hands and possibly other parts of his body. Middleware running on assembly 22 and/or computer 24 processes the 3D map data to extract a skeleton of the body, including 3D locations and orientations of the user's hands and joints. It may also analyze the trajectory of the hands over multiple frames in order to identify gestures delineated by the hands. The skeleton and gesture information are provided via an API to an application program running on computer 24. This program may, for example, move and modify objects 30 presented on display 26 in response to the skeleton and/or gesture information. For example, the application program may be an interactive game, in which the user interacts with objects 30 in a virtual space by moving his or her body appropriately.

Computer 24 typically comprises a general-purpose computer processor, which is programmed in software to carry out the functions described hereinbelow. The software may be downloaded to the processor in electronic form, over a network, for example, or it may alternatively be provided on tangible media, such as optical, magnetic, or electronic memory media. Alternatively or additionally, some or all of the functions of the computer may be implemented in dedicated hardware, such as a custom or semi-custom integrated circuit or a programmable digital signal processor (DSP). Although computer 24 is shown in FIG. 1, by way of example, as a separate unit from imaging assembly 22, some or all of the processing functions of the computer may be performed by a suitable microprocessor or dedicated circuitry within the housing of the imaging assembly or otherwise associated with the imaging assembly.

As another alternative, at least some of these processing functions may be carried out by a suitable processor that is integrated with display screen 26 (in a television set, for example) or with any other suitable sort of computerized device, such as a game console or media player. The sensing functions of assembly 22 may likewise be integrated into the computer or other computerized apparatus that is to be controlled by the sensor output.

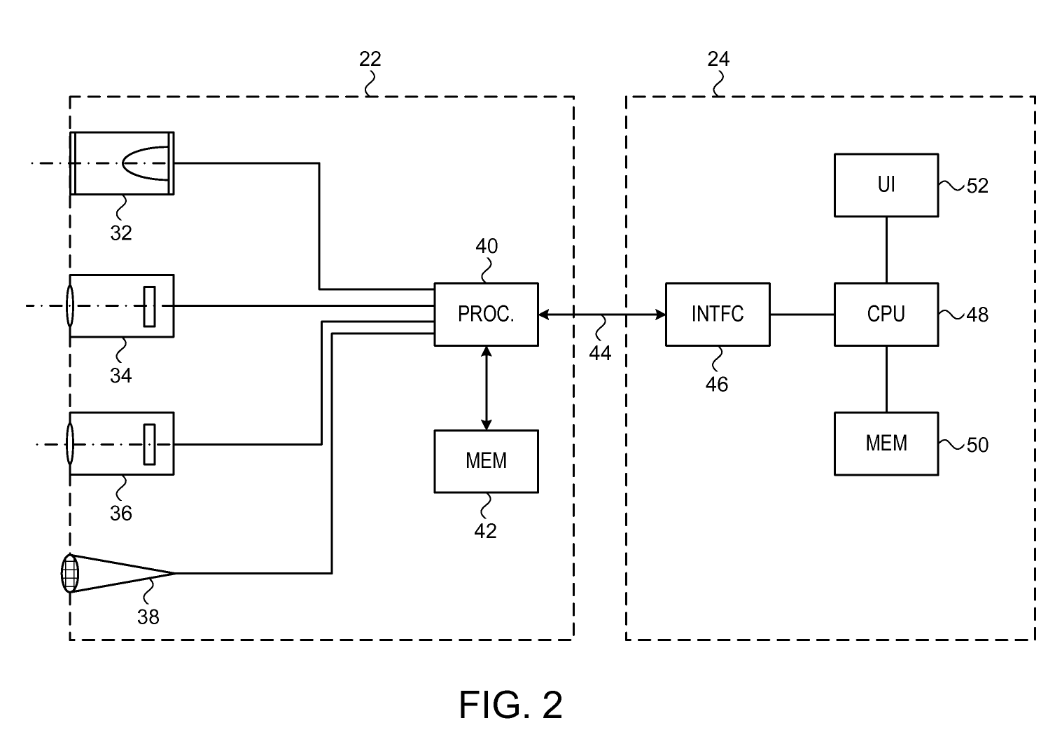

FIG. 2 is a block diagram that schematically illustrates elements of imaging assembly 22 and computer 24 in system 20, in accordance with an embodiment of the present invention. Imaging assembly 22 comprises an illumination subassembly 32, which projects a pattern onto the scene of interest. A depth imaging subassembly 34, such as a suitably-configured video camera, captures images of the pattern on the scene. Typically, illumination subassembly 32 and imaging subassembly 34 operate in the infrared range, although other spectral ranges may also be used. Optionally, a color video camera 36 captures 2D color images of the scene, and a microphone 38 may also capture sound.

A processor 40 receives the images from subassembly 34 and compares the pattern in each image to a reference pattern stored in a memory 42. The reference pattern is typically captured in advance by projecting the pattern onto a reference plane at a known distance from assembly 22. Generally, this plane is perpendicular to the optical axis of subassembly 34. Processor 40 computes local shifts of parts of the pattern over the area of the depth map and translates these shifts into depth coordinates. Details of this process are described, for example, in PCT International Publication WO 2010/004542, whose disclosure is incorporated herein by reference. Alternatively, as noted earlier, assembly 22 may be configured to generate depth maps by other means that are known in the art, such as stereoscopic imaging or time-of-flight measurements.

Processor 40 outputs the depth maps via a communication link 44, such as a Universal Serial Bus (USB) connection, to a suitable interface 46 of computer 24. The computer comprises a central processing unit (CPU) 48 with a memory 50 and a user interface 52, which drives display 26 and may include other components, as well. As noted above, imaging assembly 22 may alternatively output only raw images from subassembly 34, and the depth map computation described above may be performed in software by CPU 48. Middleware for extracting higher-level information from the depth maps may run on processor 40, CPU 48, or both. CPU 48 runs one or more application programs, which drive user interface 52 based on information provided by the middleware via an API, as described further hereinbelow.

### API Structure and Operation

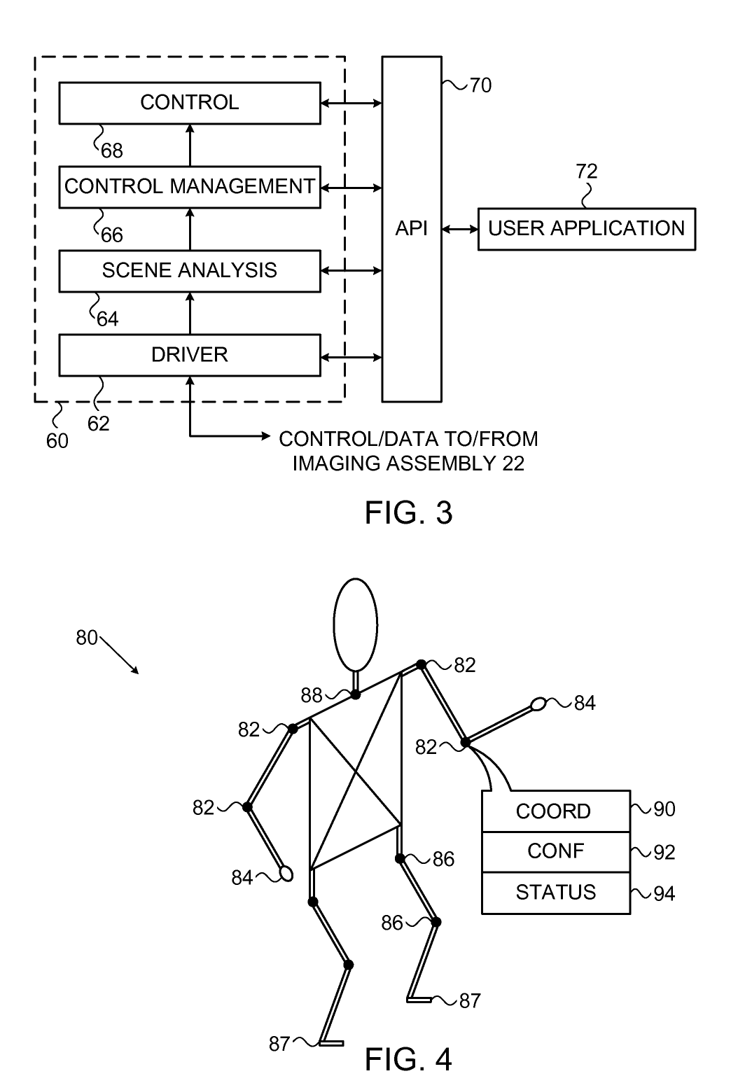

FIG. 3 is a block diagram that schematically illustrates software components supporting an interactive user application 72 running on computer 24, in accordance with an embodiment of the present invention. It will be assumed, by way of example, that application 72 is a game in which the user interacts with objects on the computer display by moving parts of his or her body; but the software structures described herein are similarly useful in supporting applications of other types. It will also be assumed, for the sake of simplicity, that computer 24 receives depth maps from imaging assembly 22 and runs the higher-level middleware functions on CPU 48. As noted above, however, some or all of the middleware functions may alternatively run on processor 40. The changes to be made in such cases to the software structure shown in FIG. 3 will be apparent to those skilled in the art after reading the description hereinbelow.

Computer 24 runs a package of middleware 60 for processing depth maps provided by imaging assembly 22 and outputting control commands to the imaging assembly as needed. Middleware 60 comprises the following layers:
A driver layer 62 receives and buffers the depth maps (and possibly other data) from assembly 22.
A scene analysis layer 64 processes the depth maps in order to extract scene information, and specifically to find skeletons of humanoid figures in the scene. (In some cases, such as applications that require only hand tracking without extraction of the entire skeleton, this layer is inactive or else extracts only the features of interest, such as the hands.)
A control management layer 66 tracks points in the skeleton (particularly the hands) and generates event notifications when hands and other body parts move or otherwise change appearance.
A control layer 68 processes the events generated by layer 66 in order to identify specific, predefined gestures.

An API 70 provides a set of objects that can be called by application 72 to access information generated by different layers of middleware 60. The API may include some or all of the following items:
Depth data (from layer 62):
   Depth value for each pixel, including “no depth” value indications, meaning that at the given pixel, processor 40 was unable to derive a significant depth value from the pattern image.
   Saturation indication for no-depth pixels, indicating that the reason for the “no depth” value at a given pixel was saturation of the sensor in imaging subassembly 34. This indication can be useful in adjusting scene lighting and/or image capture settings.
   Confidence level for each depth pixel value.
   Angle of the normal to the surface of the object in the scene at each pixel.
Skeleton (from layer 64)—see also FIG. 4, which is described below:
   Location and, optionally, orientation coordinates of joints (including identification of the body to which the joints belong, when there are multiple bodies in the scene). Orientation may be in global terms with respect to the reference coordinate system of the scene, or it may be relative to the parent body element of the joint. (For example, the elbow orientation may be the bend angle between upper and lower arm segments.
   Confidence per joint—A number between 0 to 100, for example, indicating the confidence level of the identification and coordinates of the joint.
Status indication per joint (OK, close to edge of field of view, outside field of view).
   Calibration—Permits the application to calibrate the skeleton while the user assumes a certain predefined pose, as well as to check whether the skeleton is already calibrated.
   Body part sizes—Provides body proportions (such as upper and lower arm length, upper and lower leg length, etc.)
   Mode selection—Indicates whether the scene includes the full body of the user or only the upper body, as well as the rotation angle of the body. When only the upper body is needed for a given application, upper-body mode may be selected even when the entire body appears in the scene, in order to reduce computational demands.
Other scene analyzer functions (also provided by layer 64):
   Label map, based on segmentation of the depth map to identify humanoid bodies, as well as other moving objects, such as a ball or a sword used in a game. All pixels belonging to a given body or other object (or belonging to a part of the body when not tracking the entire body, or belonging to another object being tracked) are marked with a consistent ID number, with a different ID number assigned to each body when there are multiple bodies in the scene. All other pixels in the label map are labeled with zero.
   Floor identification—Provides plane equation parameters (location and orientation) of the floor in the scene. The floor API may also provide a mask of pixels in the floor plane that appear in any given depth map.
   Walls identification—Equation parameters and possibly pixel masks, as for the floor.
   Occlusions:
      Indicates that the body of one user is hiding at least a part of another user, and may also give the duration (i.e., the number of frames) over which the occlusion has persisted.
      Mark pixels on the boundary of an occluded part of the body of a user.
   Body geometry information:
      Height of the body in real-world terms, based on the combination of body extent in the 2D plane and depth coordinates.
      Center of mass of the body.
      Area of the body in real-world terms (computed in similar fashion to the height).
      Number of pixels identified as part of the body in the depth map.
      Bounding box surrounding the body.
   Background model (far field)—Depth map or parametric representation of the scene as it would be without any user bodies. The background model may be built up over time, as the background is revealed gradually when other objects move in front of it.
User interface inputs (from layer 68):
   Hand added/deleted/moved event notifications. (Hands are added or deleted when they newly appear or disappear in a given frame, due to moving the hand into view or occlusion of the hand, for example.)
   Hand notification details:
      Locations of hands (along with ID).
      Hand point confidence level.
   Head positions.
   3D motion vectors for all skeletal joints and other identified body parts.
   Gesture notifications, indicating gesture position and type, including:
      Pointing gestures.
      Circular gestures.
      “Push” and “slide” gestures (i.e., forward or sideways translation of hand).
      “Swipe” and “wave” gestures, in which the hand describes more complex, multi-dimensional geometrical figures.
      Hand motion crossing an application-defined plane in space.
      “Focus gesture”—Predefined gesture that is used to start a gesture-based interaction
      Other application-defined gestures—The application programmer may define and input, via API 70 to layer 66, new gestures that are not part of the standard vocabulary.
      Gesture started.
      Gesture completed. (Layer 68 may also report the percentage of gesture completion.)
   API 70 also enables the application programmer to set gesture parameters in layer 66, such as the minimum distance of hand movement that is required for a gesture to be recognized or the permitted range of deviation of a hand movement from the baseline gesture definition.

As noted above, the label map provided by layer 64 may be applied not only to humanoid bodies, but also to any sort of object in the scene. It facilitates identifying and maintaining distinction between objects in a frame and over multiple frames, notwithstanding changes in apparent shape as objects move and occlusion of one object by another.

FIG. 4 is a schematic graphical representation of a skeleton 80 that is extracted by middleware 60 from a 3D map, in accordance with an embodiment of the present invention. Skeleton 80 is defined in terms of joints 82, 86, 88, etc., as well as hands 84 and feet 87. (The skeleton, in fact, is a data structure provided by middleware 60 via API 70, but is shown here graphically for clarity of explanation.) The joint data are extracted from the depth map using image processing operations, such as operations of the types described in the above-mentioned PCT International Publication WO 2007/132451 and U.S. patent application Ser. Nos. 12/854,187 and 12/854,188.

As noted above, each joint may be labeled with a number of items of information, which are available via API 70. For example, as shown in FIG. 4, elbow joint 82 is labeled with the following parameters, as defined above:
Coordinates 90, including X-Y-Z location and orientation, i.e., bend angle.
Confidence level.
Status in the 3D map frame.
   The locations of the joints, the hands, and possibly the head also serve as inputs to the upper control layers of middleware 60.

Shoulder joints 82 and hip joints 86 define the coronal plane of skeleton 80. In the example shown in FIG. 4, the coronal plane is rotated relative to the reference plane (which is parallel to the plane of the page in the figure), and the shoulders thus have different, respective depth values. Middleware 60 detects this rotation status and is able to report it via API 70.

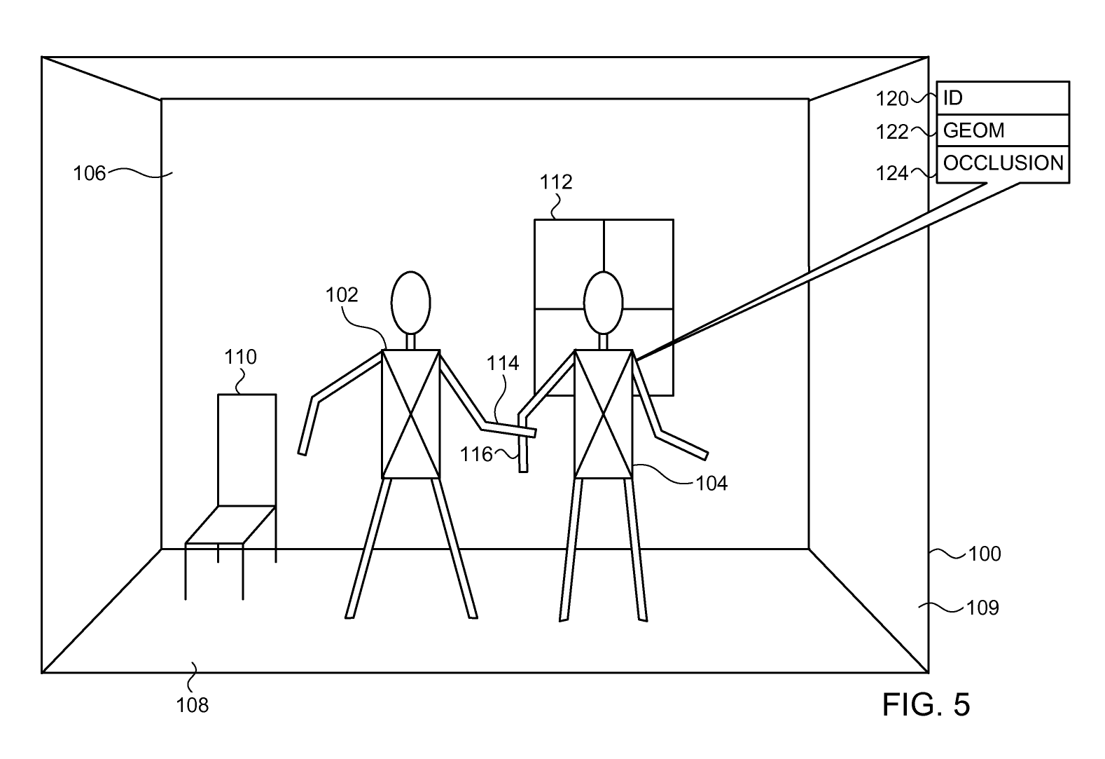

FIG. 5 is a schematic graphical representation showing elements of a scene 100 that have been extracted from a 3D map by middleware 60, in accordance with an embodiment of the present invention. In this case the scene includes skeletons 102 and 104 of two users, in a room 109 having walls 106 and a floor 108. The user skeletons, which generally move from frame to frame, are distinguished from fixed elements of the background, including walls 106, floor 108, and other background objects, such as a chair 110 and a window 112.

Middleware 60 identifies the planar structures in the scene corresponding to walls 106 and floor 108 and is able to provide information about these structures to application 72 via API 70. The information may be either in parametric form, in terms of plane equations, or as a mask of background pixels. In most applications, the background elements are not of interest, and they are stripped out of the frame using the information provided through API 70 or simply ignored.

When a scene includes more than one moving body, as in scene 100, applications using the scene information generally need accurate identification of which parts belong to each body. In FIG. 5, for example, an arm 114 of skeleton 102 cuts across and occludes a part of an arm 116 of skeleton 104. Arm 116 is therefore no longer a single connected component in the depth map. To overcome this sort of problem, middleware 60 assigns a persistent ID to each pixel that is identified as a part of a given body (with a different ID for each body). By tracking body parts from frame to frame by their IDs, the middleware is able to maintain the integrity of the parts of a skeleton even when the skeleton is partially occluded, as in the present case.

As was explained above in reference to FIG. 4, although the elements of scene 100 are shown graphically in FIG. 5, they are actually data structures, whose fields are available to application 72 via API 70. For example, skeleton 104 may be represented via the API in terms of an ID 120, joint parameters (as shown in FIG. 4), geometrical parameters 122, and occlusion parameters 124. The specific types of parameters that may be included in these API fields are listed above.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for processing data, comprising:
receiving a depth map of a scene containing a body of a humanoid subject, the depth map comprising a matrix of pixels, each pixel corresponding to a respective location in the scene and having a respective pixel depth value indicative of a distance from a reference plane to the respective location;
processing the depth map in a digital processor to extract a skeleton of at least a part of the body, the skeleton comprising multiple joints having respective coordinates; and
providing an application program interface (API) indicating at least the coordinates of the joints.

2. The method according to claim 1, wherein the skeleton comprises two shoulder joints having different, respective depth values.

3. The method according to claim 2, wherein the different depth values of shoulder joints define a coronal plane of the body that is rotated by at least 10° relative to the reference plane.

4. The method according to claim 1, wherein the API comprises a first interface providing the coordinates of the joints and a second interface providing respective depth values of the pixels in the depth map.

5. The method according to claim 1, wherein receiving the depth map comprises receiving a sequence of depth maps as the body moves, and wherein processing the depth map comprises tracking movement of one or more of the joints over the sequence, and wherein the API comprises a first interface providing the coordinates of the joints and a second interface providing an indication of gestures formed by the movement of the one or more of the joints.

6. The method according to claim 1, wherein the scene contains a background, and wherein processing the depth map comprises identifying one or more parameters of at least one element of the background, and wherein the API comprises a first interface providing the coordinates of the joints and a second interface providing the one or more parameters of the at least one element of the background.

7. The method according to claim 6, wherein the at least one element of the background comprises a planar element, and wherein the one or more parameters indicate a location and orientation of a plane corresponding to the planar element.

8. The method according to claim 1, wherein the scene contains respective bodies of two or more humanoid subjects, and wherein processing the depth map comprises distinguishing the bodies from one another and assigning a respective label to identify each of the bodies, and wherein the API identifies the coordinates of the joints of each of the bodies with the respective label.

9. The method according to claim 8, wherein distinguishing the bodies comprises identifying an occlusion of a part of one of the bodies in the depth map by another of the bodies, and wherein the API identifies the occlusion.

10. The method according to claim 1, wherein processing the depth map comprises computing a confidence value associated with an identification of an element in the scene, and wherein the API indicates the identification and the associated confidence value.

11. Apparatus for processing data, comprising:
an imaging assembly, which is configured to generate a depth map of a scene containing a body of a humanoid subject, the depth map comprising a matrix of pixels, each pixel corresponding to a respective location in the scene and having a respective pixel depth value indicative of a distance from a reference plane to the respective location; and
a processor, which is configured to process the depth map to extract a skeleton of at least a part of the body, the skeleton comprising multiple joints having respective coordinates, and to provide an application program interface (API) indicating at least the coordinates of the joints.

12. The apparatus according to claim 11, wherein the skeleton comprises two shoulder joints having different, respective depth values.

13. The apparatus according to claim 12, wherein the different depth values of shoulder joints define a coronal plane of the body that is rotated by at least 10° relative to the reference plane.

14. The apparatus according to claim 11, wherein the API comprises a first interface providing the coordinates of the joints and a second interface providing respective depth values of the pixels in the depth map.

15. The apparatus according to claim 11, wherein the imaging assembly is configured to generate a sequence of depth maps as the body moves, and wherein the processor is configured to track movement of one or more of the joints over the sequence, and wherein the API comprises a first interface providing the coordinates of the joints and a second interface providing an indication of gestures formed by the movement of the one or more of the joints.

16. The apparatus according to claim 11, wherein the scene contains a background, and wherein the processor is configured to identify one or more parameters of at least one element of the background, and wherein the API comprises a first interface providing the coordinates of the joints and a second interface providing the one or more parameters of the at least one element of the background.

17. The apparatus according to claim 16, wherein the at least one element of the background comprises a planar element, and wherein the one or more parameters indicate a location and orientation of a plane corresponding to the planar element.

18. The apparatus according to claim 11, wherein the scene contains respective bodies of two or more humanoid subjects, and wherein the processor is configured to distinguish the bodies from one another and to assign a respective label to identify each of the bodies, and wherein the API identifies the coordinates of the joints of each of the bodies with the respective label.

19. The apparatus according to claim 18, wherein the processor is configured to identify an occlusion of a part of one of the bodies in the depth map by another of the bodies, and wherein the API identifies the occlusion.

20. The apparatus according to claim 11, wherein the processor is configured to compute a confidence value associated with an identification of an element in the scene, and wherein the API indicates the identification and the associated confidence value.

21. A computer software product, comprising a computer-readable medium in which program instructions are stored, which instructions, when read by a processor, cause the processor to receive a depth map of a scene containing a body of a humanoid subject, the depth map comprising a matrix of pixels, each pixel corresponding to a respective location in the scene and having a respective pixel depth value indicative of a distance from a reference plane to the respective location, to process the depth map to extract a skeleton of at least a part of the body, the skeleton comprising multiple joints having respective coordinates, and to provide an application program interface (API) indicating at least the coordinates of the joints.

22. The product according to claim 21, wherein the skeleton comprises two shoulder joints having different, respective depth values.

23. The product according to claim 12, wherein the different depth values of shoulder joints define a coronal plane of the body that is rotated by at least 10° relative to the reference plane.

24. The product according to claim 21, wherein the API comprises a first interface providing the coordinates of the joints and a second interface providing respective depth values of the pixels in the depth map.

25. The product according to claim 21, wherein the instructions cause the processor to receive a sequence of depth maps as the body moves and to track movement of one or more of the joints over the sequence, and wherein the API comprises a first interface providing the coordinates of the joints and a second interface providing an indication of gestures formed by the movement of the one or more of the joints.

26. The product according to claim 21, wherein the scene contains a background, and wherein the instructions cause the processor to identify one or more parameters of at least one element of the background, and wherein the API comprises a first interface providing the coordinates of the joints and a second interface providing the one or more parameters of the at least one element of the background.

27. The product according to claim 26, wherein the at least one element of the background comprises a planar element, and wherein the one or more parameters indicate a location and orientation of a plane corresponding to the planar element.

28. The product according to claim 21, wherein the scene contains respective bodies of two or more humanoid subjects, and wherein the instructions cause the processor to distinguish the bodies from one another and to assign a respective label to identify each of the bodies, and wherein the API identifies the coordinates of the joints of each of the bodies with the respective label.

29. The product according to claim 18, wherein the instructions cause the computer to identify an occlusion of a part of one of the bodies in the depth map by another of the bodies, and wherein the API identifies the occlusion.

30. The product according to claim 21, wherein the instructions cause the computer to compute a confidence value associated with an identification of an element in the scene, and wherein the API indicates the identification and the associated confidence value.

31. A method for processing data, comprising:
receiving a depth map of a scene comprising a matrix of pixels, each pixel corresponding to a respective location in the scene and having a respective pixel depth value indicative of a distance from a reference plane to the respective location;
segmenting the depth map in a digital processor to identify one or more objects in the scene;
generating a label map comprising respective labels identifying the pixels belonging to the one or more objects; and
providing an indication of the label map via an application program interface (API).

32. The method according to claim 31, wherein receiving the depth map comprises receiving a sequence of depth maps as the objects move, and wherein generating the label map comprises updating the label map over the sequence responsively to movement of the objects.

33. The method according to claim 31, wherein at least one of the objects comprises multiple segments, and wherein generating the label map comprises assigning a single label to all of the segments.

34. The method according to claim 31, wherein segmenting the depth map comprises recognizing an occlusion of a part of one of the identified objects in the depth map by another object, and wherein generating the label map comprises identifying the occlusion in the label map.

35. Apparatus for processing data, comprising:
an imaging assembly, which is configured to generate a depth map of a scene comprising a matrix of pixels, each pixel corresponding to a respective location in the scene and having a respective pixel depth value indicative of a distance from a reference plane to the respective location; and
a processor, which is configured to segment the depth map to identify one or more objects in the scene, to generate a label map comprising respective labels identifying the pixels belonging to the one or more objects, and to provide an indication of the label map via an application program interface (API).

36. The apparatus according to claim 35, wherein the imaging assembly is configured to generate a sequence of depth maps as the objects move, and wherein the processor is configured to update the label map over the sequence responsively to movement of the objects.

37. The apparatus according to claim 35, wherein at least one of the objects comprises multiple segments, and wherein the processor is configured to assign a single label to all of the segments.

38. The apparatus according to claim 35, wherein the processor is configured to recognize an occlusion of a part of one of the identified objects in the depth map by another object, and to generate the label map so as to identify the occlusion.

39. A computer software product, comprising a computer-readable medium in which program instructions are stored, which instructions, when read by a processor, cause the processor to receive a depth map of a scene comprising a matrix of pixels, each pixel corresponding to a respective location in the scene and having a respective pixel depth value indicative of a distance from a reference plane to the respective location, to segment the depth map to identify one or more objects in the scene, to generate a label map comprising respective labels identifying the pixels belonging to the one or more objects, and to provide an indication of the label map via an application program interface (API).

40. The product according to claim 39, wherein the imaging assembly is configured to generate a sequence of depth maps as the objects move, and wherein the instructions cause the processor to update the label map over the sequence responsively to movement of the objects.

41. The product according to claim 39, wherein at least one of the objects comprises multiple segments, and wherein the instructions cause the processor to assign a single label to all of the segments.

42. The product according to claim 39, wherein the instructions cause the processor to recognize an occlusion of a part of one of the identified objects in the depth map by another object, and to generate the label map so as to identify the occlusion.
